(19) United States
(12) Patent Application Publication
(10) Pub. No.: US 2024/0353358 A1
(43) Pub. Date: Oct. 24, 2024

(54) Radiation Effects Testing System with a Beam Accelerator

(71) Applicant: SHINE Technologies, LLC, Janesville, WI (US)

(72) Inventors: Craig Jacobson, Oregon, WI (US); Jim Wagner, Madison, WI (US); Lucas Jacobson, Madison, WI (US); Mike Philipps, Stoughton, WI (US); Scott Biba, Waunakee, WI (US); Jeff Wong, Middleton, WI (US)

(73) Assignee: SHINE Technologies, LLC, Janesvillevvvvvvvv, WI (US)

(21) Appl. No.: 18/645,058

(22) Filed: Apr. 24, 2024

Related U.S. Application Data
(60) Provisional application No. 63/461,517, filed on Apr. 24, 2023.

(51) Int. Cl. G01N 23/222; G01N 23/2204

(52) U.S. Cl. CPC G01N 23/222; G01N 23/2204; G01N 2223/1066

(57) ABSTRACT

A radiation effects testing system that includes a sample test housing comprising a housing body and a sample chamber within the housing body and a neutron generator comprising a beam accelerator configured to generate an ion beam, a target chamber, and a beamline extending from the beam accelerator to the target chamber. The sample test housing and target chamber are each housed in a bunker comprising a bunker floor and one or more bunker walls, water is positioned in the bunker forming a water pool, and the sample test housing and the target chamber are positioned in the water pool.

### CROSS-REFERENCE TO RELATED APPLICATIONS

This application claims the benefit of U.S. Provisional Application No. 63/461,517 filed on Apr. 24, 2023, which is incorporated herein by reference in its entirety.

### BACKGROUND

The present disclosure is generally directed radiation effects testing systems, such as, for example, radiation effects testing systems that include a neutron generator having a beam accelerator.

### SUMMARY

According to one embodiment of the present disclosure, a radiation effects testing system comprises a sample test housing comprising a housing body and a sample chamber within the housing body and a neutron generator comprising a beam accelerator configured to generate an ion beam, a target chamber, and a beamline extending from the beam accelerator to the target chamber, wherein the sample test housing and target chamber are each housed in a bunker comprising a bunker floor and one or more bunker walls, water is positioned in the bunker forming a water pool, and the sample test housing and the target chamber are positioned in the water pool.

According to another embodiment of the present disclosure, a method of performing radiation effects testing comprises loading a test sample into a sample chamber of a sample test housing, generating neutrons in a target chamber of a neutron generator positioned such that the neutrons irradiate the test sample in the sample chamber, and removing the test sample from the sample chamber, wherein the sample test housing and target chamber are each housed in a bunker comprising a bunker floor and one or more bunker walls and when generating neutrons in the target chamber, water is positioned in the bunker forming a water pool such that the sample test housing and the target chamber are positioned in the water pool.

Additional features and advantages will be set forth in the detailed description which follows, and in part will be readily apparent to those skilled in the art from that description or recognized by practicing the embodiments described herein, including the detailed description which follows, the claims, as well as the appended drawings.

It is to be understood that both the foregoing general description and the following detailed description describe various embodiments and are intended to provide an overview or framework for understanding the nature and character of the claimed subject matter. The accompanying drawings are included to provide a further understanding of the various embodiments and are incorporated into and constitute a part of this specification. The drawings illustrate the various embodiments described herein, and together with the description serve to explain the principles and operations of the claimed subject matter.

### BRIEF DESCRIPTION OF THE DRAWINGS

FIG. 1 schematically depicts an embodiment of a radiation effects testing system that includes a neutron generator, a sample test housing, and a sample loading system according to embodiments disclosed and described herein;

FIG. 2 schematically depicts the sample test housing and the sample loading system of FIG. 1 in more detail, according to one or more embodiments disclosed and described herein;

FIG. 3 schematically depicts a partial cut away view of the sample test housing and the sample loading system of FIG. 2, according to one or more embodiments disclosed and described herein;

FIG. 4 schematically depicts another partial cut away view of the sample test housing and the sample loading system of FIG. 2, according to one or more embodiments disclosed and described herein;

FIG. 5 schematically depicts a partial cut away view of a loading end of a loading duct of the sample loading system of FIG. 2, according to one or more embodiments disclosed and described herein;

FIG. 6 schematically depicts a duct plug positioned in a loading duct of a sample loading system, according to one or more embodiments disclosed and described herein;

FIG. 7 schematically depicts an embodiment of a radiation effects testing system that includes a neutron generator, a sample test housing, and an access tubing system according to embodiments disclosed and described herein;

FIG. 8 schematically depicts the sample test housing and the access tubing system of FIG. 7 in more detail, according to one or more embodiments disclosed and described herein;

FIG. 9A depicts thermal neutron flux modeling in a radiation effects testing system having an irradiation frame that includes a neutron absorption liner, according to one or more embodiments disclosed and described herein;

FIG. 9B depicts thermal neutron flux modeling in a radiation effects testing system having an irradiation frame that does not include a neutron absorption liner, according to one or more embodiments disclosed and described herein;

FIG. 9C depicts fusion neutron flux modeling in a radiation effects testing system having an irradiation frame that includes a neutron absorption liner, according to one or more embodiments disclosed and described herein;

FIG. 9D depicts fusion neutron flux modeling in a radiation effects testing system having an irradiation frame that does not include a neutron absorption liner, according to one or more embodiments disclosed and described herein;

FIG. 10A depicts modeling of a single event upset rate from thermal neutrons in a radiation effects testing system having an irradiation frame that includes a neutron absorption liner, according to one or more embodiments disclosed and described herein;

FIG. 10B depicts modeling of a single event upset rate from thermal neutrons in a radiation effects testing system having an irradiation frame that does not include a neutron absorption liner, according to one or more embodiments disclosed and described herein;

FIG. 10C depicts modeling of a single event upset rate from fusion neutrons in a radiation effects testing system having an irradiation frame that includes a neutron absorption liner, according to one or more embodiments disclosed and described herein;

FIG. 10D depicts modeling of a single event upset rate from fusion neutrons in a radiation effects testing system having an irradiation frame that does not include a neutron absorption liner, according to one or more embodiments disclosed and described herein;

FIG. 11A depicts modeling of a single event upset rate from fusion neutrons comprising an energy greater than 10 MeV in a radiation effects testing system along a vertical plane, the radiation effects testing system having an irradiation frame that includes a neutron absorption liner, according to one or more embodiments disclosed and described herein;

FIG. 11B depicts modeling of a single event upset rate from fusion neutrons comprising an energy greater than 10 MeV in a radiation effects testing system along a vertical plane, the radiation effects testing system having an irradiation frame that does not include a neutron absorption liner, according to one or more embodiments disclosed and described herein;

FIG. 11C depicts the model of FIG. 11A along a horizontal plane, according to one or more embodiments disclosed and described herein; and

FIG. 11D depicts the model of FIG. 11C along a horizontal plane, according to one or more embodiments disclosed and described herein.

### DETAILED DESCRIPTION

Reference will now be made in detail to embodiments of radiation effects testing systems that include a neutron generator and a sample test housing, embodiments of which are illustrated in the accompanying drawings. The radiation effects testing system operates as a fusion-prototypic neutron source (FPNS) for testing electronics and other components and materials under neutron bombardment. For example, the neutron generator is an accelerator-based neutron generator that includes a beam accelerator configured to form and accelerate an ion beam along a beamline that terminates at a target chamber. The target chamber houses a target that interacts with the ion beam to generate neutrons. The sample test housing includes one of more sample chambers for housing a test sample, and is positioned near the target chamber, for example, surrounding the target chamber. Thus, neutrons generated in the target chamber reach the one or more sample chambers and irradiate test samples located in the one or more sample chambers.

In some embodiments, the neutron generator is configured to generate neutrons with a high neutron flux in the 14.1 MeV spectrum to emulate the neutron-induced damage of a deuterium-tritium reaction on materials. Thus, the radiation effects testing system could be used to qualify materials and electronic components for use in areas of fusion power development, aerospace, and defense. For example, the materials that will be used in fusion reactors will be subjected to intense fluxes of 14.1 MeV neutrons during operation from the deuterium-tritium (DT) reaction. This will occur in multiple locations within a fusion reactor, such as the plasma-facing and inner wall components of a vacuum vessel and the structural materials within the tritium breeding blanket. Independent of the technology used to achieve fusion, the materials used are expected to incur doses of 20 to 50 displacements per atom (dpa) per full power year (fpy) at temperatures ranging from 300° C. to 1000° C. Additionally, conventional tritium breeding techniques mix breeding materials with structural materials. The radiation effects testing system described herein may also be used to test the integrity of the solid breeder materials under these same conditions. Moreover, the high energy neutrons generated using the neutron generator may be used to test the integrity and operational capabilities of components, such as electronic components, by emulating neutron irradiation that can occur in outer space, such as in earth orbit or deep space, and emulating the high energy neutrons that defense and other infrastructure components would undergo in the event of a nuclear incident. Accordingly, the radiation effects testing system can help solve some of the difficult challenges of designing and building materials and electronics capable of withstanding intense neutron environments, supporting the realization of fusion power as a commercially viable energy source, and supporting the development of aerospace and defense related components.

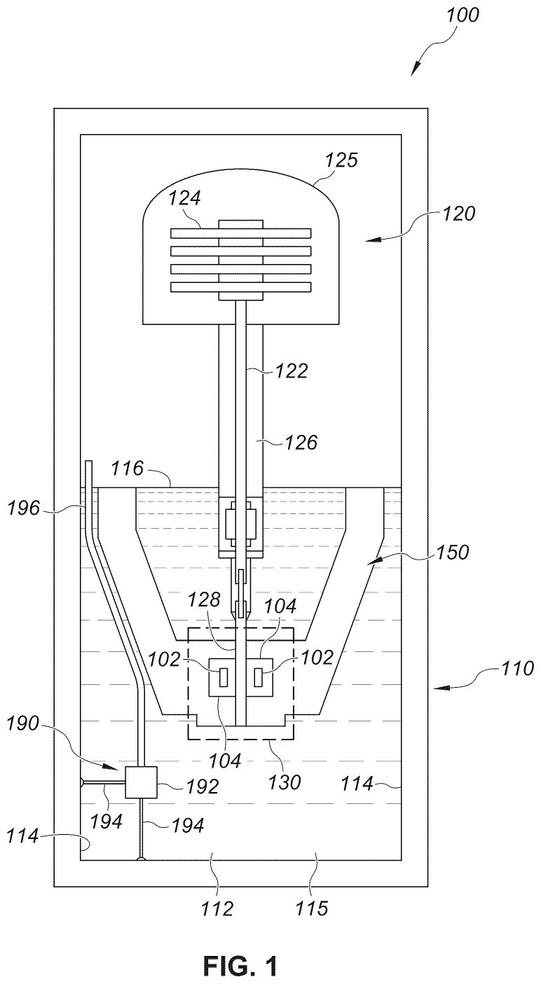

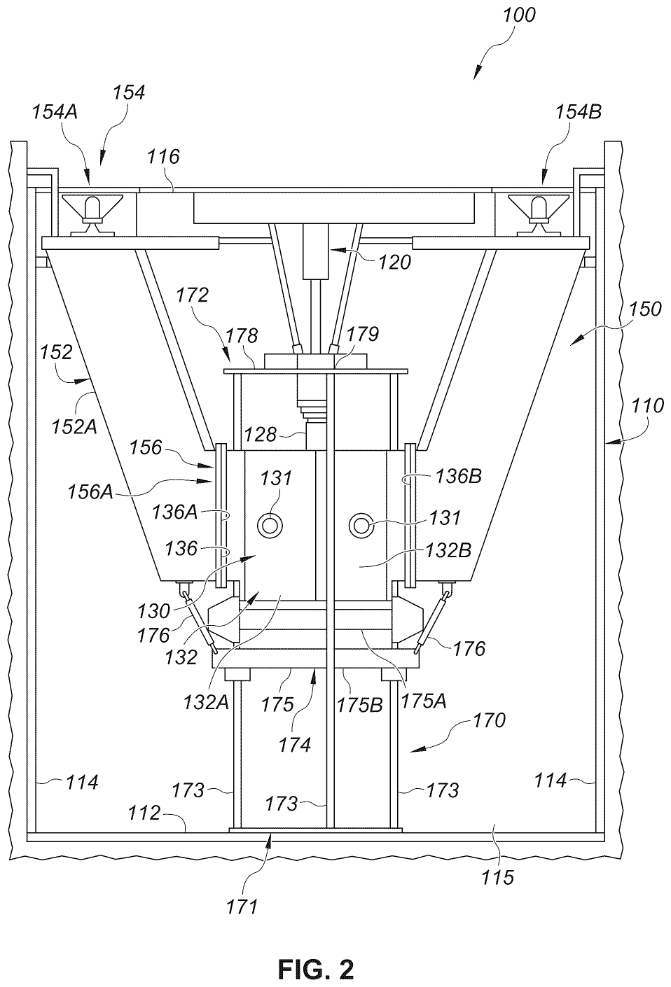

Referring now to FIGS. 1 and 2, a radiation effects testing system 100 comprising a neutron generator 120, a sample test housing 130, a sample loading system 150, and target support structure 170 (FIG. 2) is schematically depicted. The neutron generator 120 is configured to produce neutrons to irradiate a test sample 102. The sample test housing 130 is configured to house one or more test samples 102 during operation. The sample loading system 150 provides a pathway and a system for loading and unloading test samples 102 from one or more sample chambers 134 of the sample test housing 130. The target support structure 170, the sample test housing 130, and at least a target chamber 128 of the neutron generator 120 are positioned in a bunker 110 comprising a bunker floor 112, one or more bunker walls 114, and may include a water pool 115 comprising a depth extending from the bunker floor 112 to a water line 116. The water in the water pool 115 may comprise light water or heavy water. The target support structure 170 provides physical support for the sample test housing 130, and the sample loading system 150 and helps hold them in place both when the water pool 115 is present and when the water pool 115 is removed (e.g., drained from the bunker 110). The water pool 115 may be fluidly coupled to a fluid pumping system configured to selectively remove water from the bunker 110 and direct water into the bunker 110 to form and remove the water pool 115. When the water pool 115 is present in the bunker, the sample test housing 130 and the target chamber 128 are positioned in the water pool 115 below the water line 116, for example, wholly below the water line 116 The water pool 115 provides neutron moderation in the bunker 110 and, as described in more detail below, the sample loading system 150 provides a dry pathway for test samples 102 to be loaded and unloaded from the sample test housing 130.

Referring still to FIGS. 1 and 2, the neutron generator 120 comprises a beamline 122 extending from a beam accelerator 124 to a target chamber 128. A low-pressure chamber 126 is positioned along the beamline 122 to provide a low-pressure environment for ion beam travel. Indeed, the beam accelerator 124 configured to generate an ion beam that is directed to the low-pressure chamber 126 (e.g., a beam accelerator region). In some embodiments, the beam accelerator 124 is housed within a high-voltage dome 125. In embodiments, the low-pressure chamber 126 is operated under vacuum conditions. The target chamber 128 houses a target, which may comprise a target gas, such as deuterium, tritium, helium, or argon, for embodiments in which neutrons are generated using a fusion reactions, or alternatively may comprise a solid target, for example, a beryllium target, for embodiments in which neutrons are generated using a spallation reaction. It should be understood that the neutron generator 120 in FIG. 1 is merely schematic and is not to scale. In some embodiments, the neutron generator 120 operates by first extracting a beam of deuterium from the beam accelerator 124, which may comprise an electron cyclotron resonance (ECR) based ion source. The deuterium beam is accelerated via stepped electrostatic potentials such that a desired deuterium-tritium fusion cross-section is achieved when the deuterium beam enters the gaseous tritium target, located in the target chamber 128, generating neutrons via a fusion reaction. In some embodiments, the deuterium beam is focused through a gas-flow-restricting aperture that separates the beam acceleration region (e.g., the low-pressure chamber 126) from the target chamber 128.

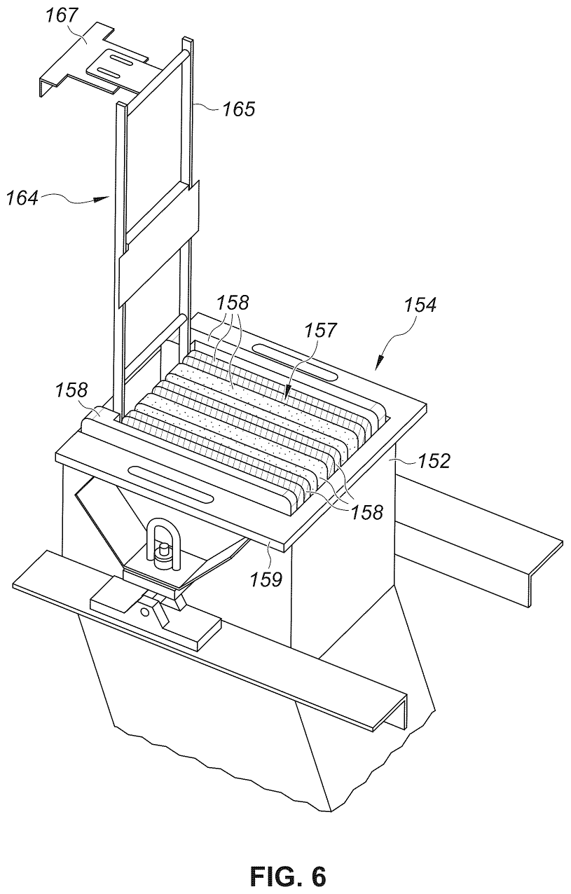

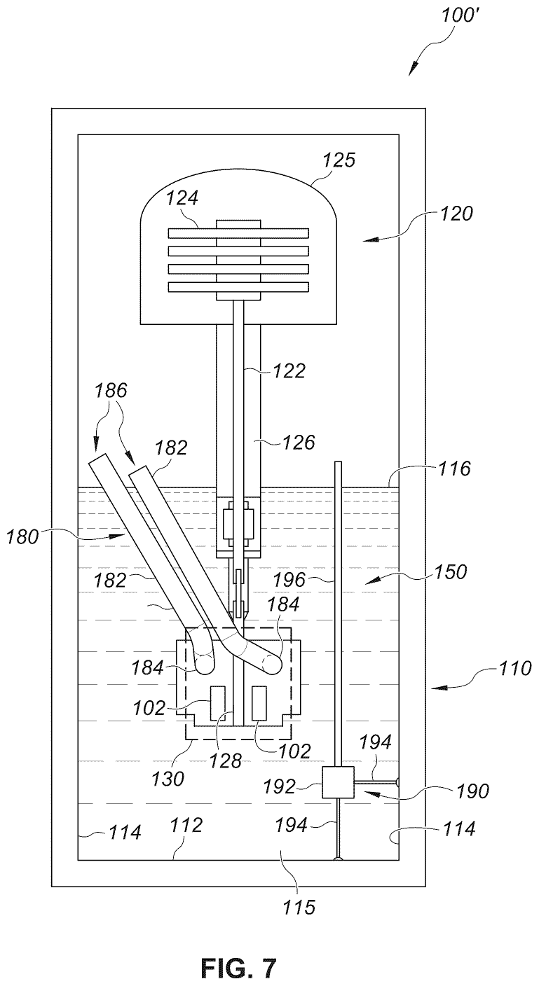

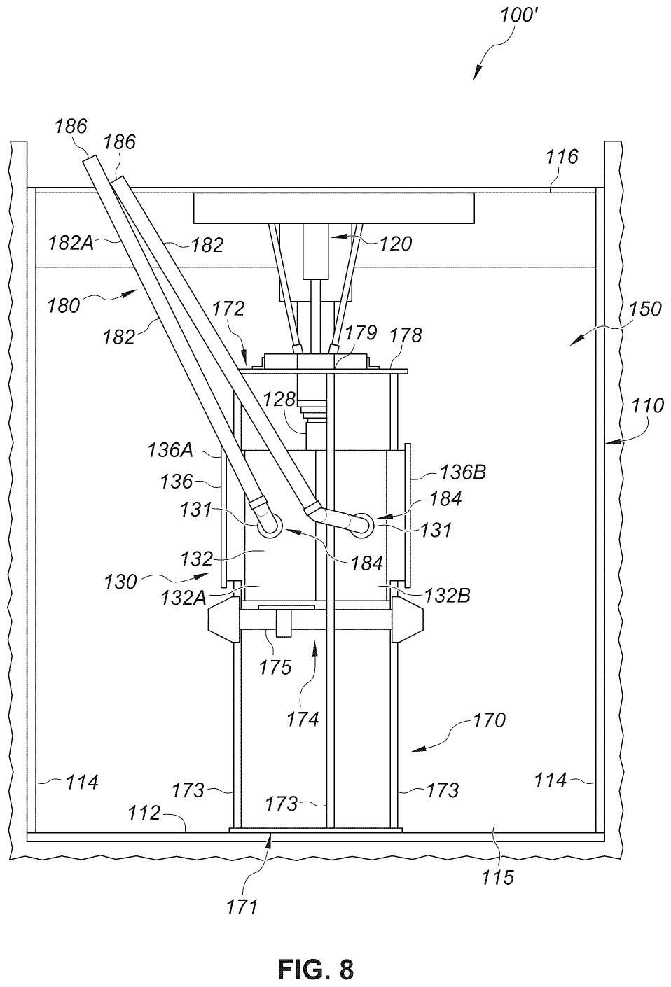

Referring now to FIGS. 1-4, the sample test housing 130 comprises one or more housing bodies 132 and the one or more sample chambers 134 are located inside the one or more housing bodies 132. Each housing body 132 separates the water of the water pool 115 from a sample chamber 134, providing a dry location for test samples 102 to be irradiated. The sample test housing 130 includes one or more sample openings 136 in the housing body 132. The one or more sample openings 136 provide openings to the one or more sample chambers 134 and may be coupled to loading ducts 152 of the sample loading system 150. In some embodiments, the sample test housing 130 includes one or more chamber ports 131, for example, a chamber port 131 for each sample chamber 134. Each chamber port 131 provides an alternative opening into the one or more sample chambers 134. For example, FIGS. 7 and 8 depict a radiation effects testing system 100′ that includes an access tubing system 180. Access tubes 182 of the access tubing system 180 may be coupled to the chamber ports 131.

Referring still to FIGS. 1-4, the sample loading system 150 is coupled to the sample test housing 130. The sample loading system 150 comprises one or more loading ducts 152 each comprising a loading end 154 and a chamber end 156. The chamber end 156 is coupled to the sample opening 136 of the sample test housing 130, thereby providing a pathway from the loading end 154 to the sample chamber 134. For example, when the water pool 115 is present in the bunker 110, the loading end 154 of each of the one or more loading ducts 152 is positioned above the water line 116, to provide a dry pathway to load test samples 102 into the one or more sample chambers 134 and remove the one or more test samples 102 from the one or more sample chambers 134.

In the embodiment depicted in FIGS. 2-4, the sample test housing 130 comprises a first housing body 132A, a first sample chamber 134A within the first housing body 132A, a first sample opening 136A in the housing body 132A, which opens to the first sample chamber 134A. The sample test housing 130 also comprises a second housing body 132B, a second sample chamber 134B within the second housing body 132B, a second sample opening 136B in the housing body 132B, which opens to the second sample chamber 134B. The sample loading system 150 comprises a first loading duct 152A coupled to the first sample opening 136A of the sample test housing 130 and a second loading duct 152B coupled to the second sample opening 136B of the sample test housing 130. While the sample test housing of 130 depicted in FIGS. 2-4 includes two housing bodies 132A, 132B and two sample chambers 134A, 134B and the sample loading system 150 comprises two loading ducts, it should be understood that any number of housing bodies 132, sample chambers 134, and loading ducts 152 are contemplated. Indeed, embodiments are contemplated with a single housing body 132 and a single sample chamber 134 connected to one or more loading ducts 152 and embodiments are contemplated having three or more housing bodies 132, three or more sample chambers 134, and three or more loading ducts 152 where at least one loading duct 152 is coupled to each of the three or more sample chambers 134.

Referring still to FIGS. 1-4, in some embodiments, the target chamber 128 of the neutron generator 120 is positioned such that the sample test housing 130 surrounds the target chamber 128. For example, the first housing body 132A is positioned adjacent the second housing body 132B such that the first housing body 132A and the second housing body 132B collectively surround the target chamber 128 of the neutron generator 120. In some embodiments, the first housing body 132A is coupled to the second housing body 132B. The sample test housing 130 further comprises a source receiving slot 138 and the target chamber 128 of the neutron generator 120 is positioned in the source receiving slot 138 such that the sample test housing 130 surrounds the target chamber 128. In some embodiments, as shown in FIGS. 2-4, the source receiving slot is collectively formed by indented portions 139 of each housing body 132, which collectively surround the target chamber 128 and separate the target chamber 128 from the sample chamber 134. The source receiving slot 138 allows the target chamber 128 to be in close proximity to the sample chamber 134 and the test sample 102, without entering the sample chamber 134, allowing the sample chamber 134 to remain dry. Moreover, positioning the one or more sample chambers 134 around the target chamber 128, maximizes the neutron flux within each sample chamber 134 and thus the neutron flux that impinges the test sample 102. While the radiation effects testing system 100 is primarily described in which the sample test housing 130 surrounds the target chamber 128 of the neutron generator 120, embodiments are contemplated in which the target chamber 128 is positioned near the sample test housing 130, for example adjacent the sample test housing 130 without being surrounded by the sample test housing 130. Such examples include embodiments in which the sample test housing 130 comprises a single housing body 132 and a single sample chamber 134. Alternatively, it is contemplated that a sample test housing 130 comprising a single housing body 132 and a single sample chamber 134 may include a source receiving slot 139 extending into the single housing body 132 such that the single sample chamber 134 surrounds the source receiving slot 139 and surrounds the target chamber 128 positioned therein.

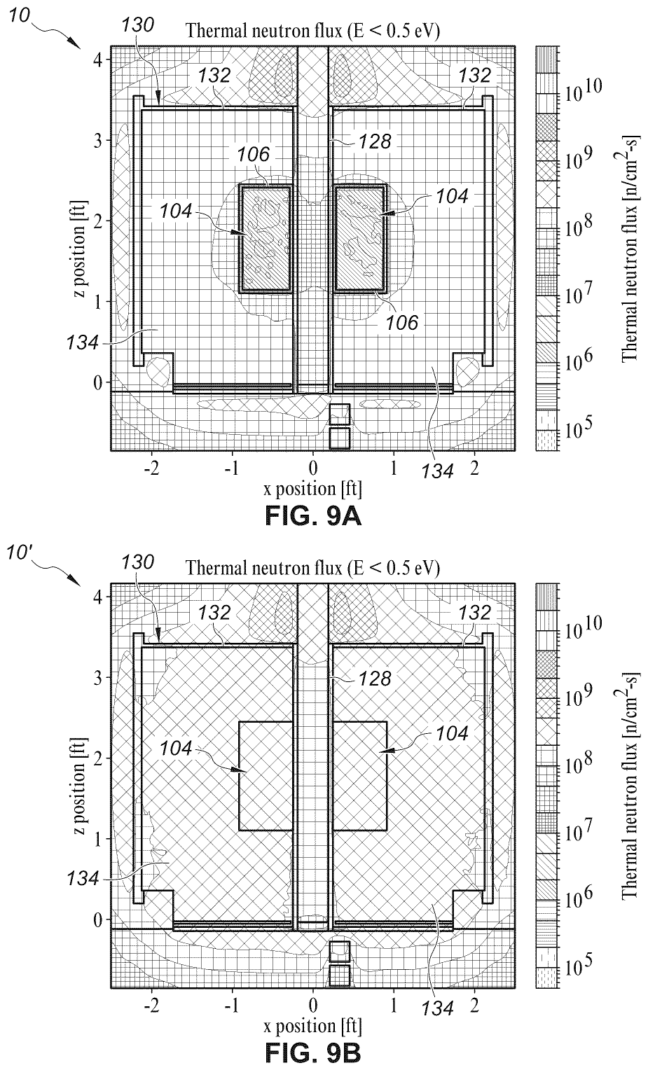

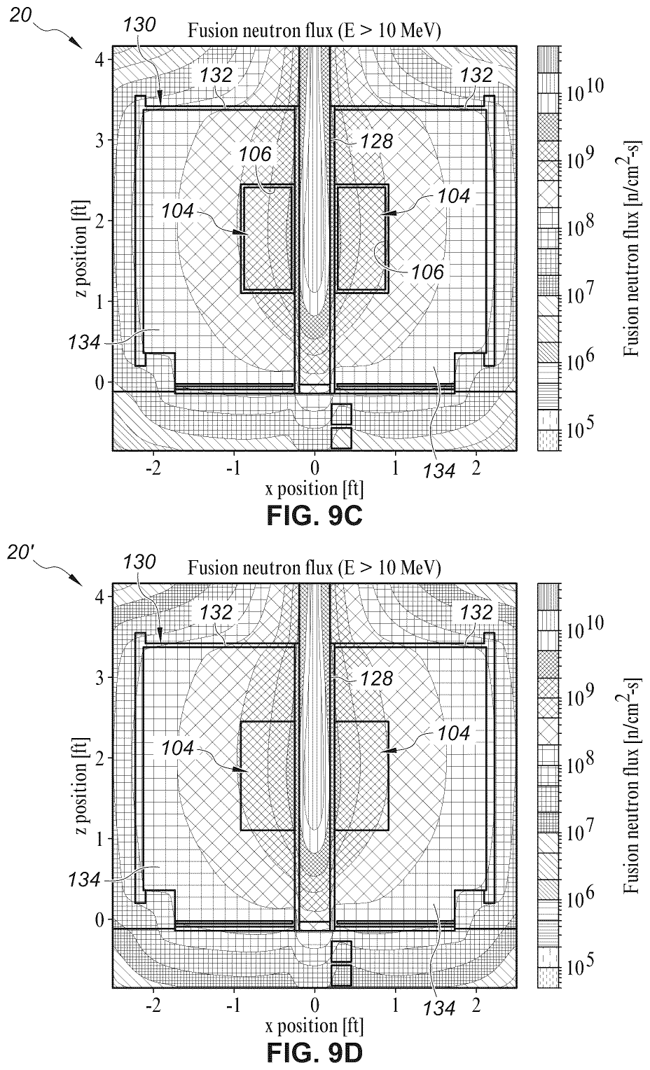

Referring now to FIGS. 1-5, the radiation effects testing system 100 further comprises one or more irradiation frames 104 translatable along the one or more loading ducts 152 of the sample loading system 150, for example, between the loading end 154 and the chamber end 156 and positionable in the one or more sample chambers 134. Each irradiation frame 104 is configured to hold one or more test samples 102 and transport the one or more test samples 102 into and out of the one or more sample chambers 134. In operation, the test sample 102 is held on or within the irradiation frame 104 during testing (e.g., while the test sample 102 is irradiated by neutrons). The one or more test samples 102 may be attached to the interior or exterior of the irradiation frame 104, which may include one or more optical breadboards for mounting electronics. Openings in the one or more optical breadboards or other openings in the irradiation frame 104 may provide a pathway for wiring of test samples 102 to exit the irradiation frame 104, allowing the test samples 102 to be powered and operational during testing. As shown in FIG. 9A, the irradiation frame 104 may further include a neutron absorption liner 106 positioned inside the irradiation frame 104, for example, lining at least a portion of the inner walls of the irradiation frame 104. The neutron absorption liner 106 may comprise a boron carbide material (e.g., a porous boron carbide material, a boron carbide powder in an epoxy matrix, or the like), borated polyethylene, or any other known or yet to be developed neutron absorbing material. In operation, the neutron absorption liner 106 preferentially absorbs or otherwise blocks thermal neutrons with minimal absorption of DT fusion neutrons. As used herein, “thermal neutrons” refer to neutrons having an energy of 1 eV or less, “fast neutrons” refer to neutrons having an energy of 1 MeV or greater, and “DT fusion neutrons” refer to neutrons generated by DT fusion, which typically have an energy of greater than 10 MeV, for example, 14.1 MeV.

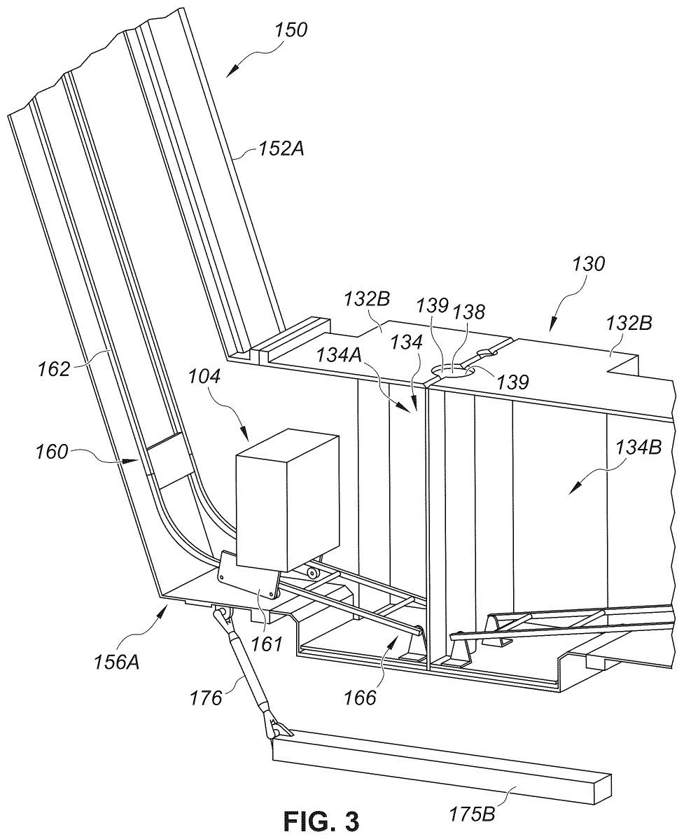

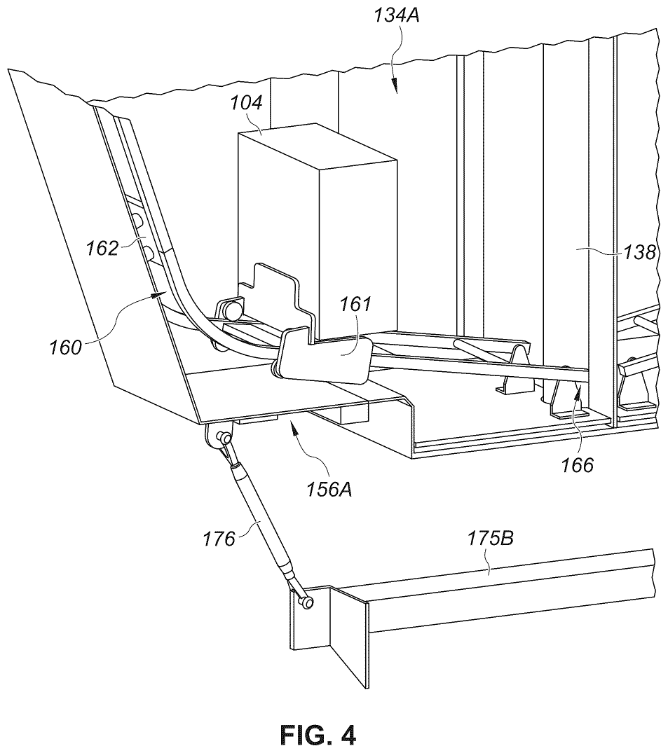

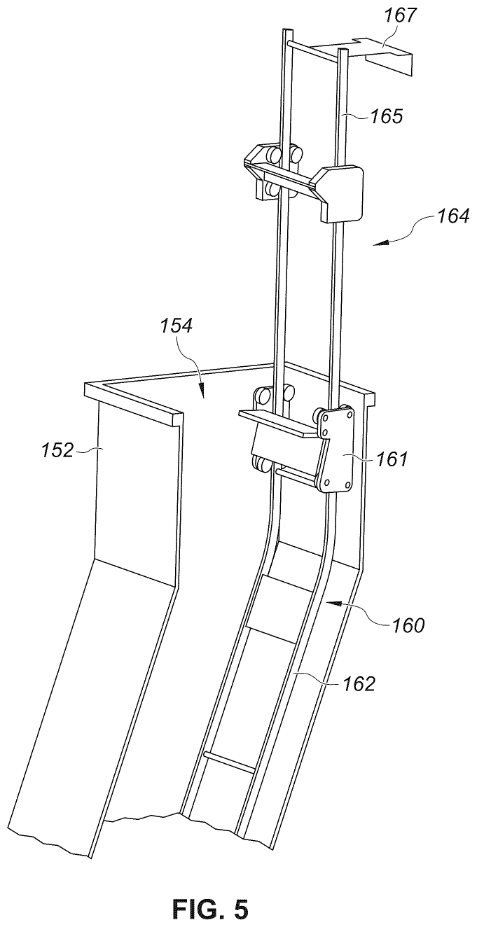

Referring now to FIGS. 3-5, in some embodiments, a rail system 160 is positioned in the one or more loading ducts 152. The rail system 160 comprises a railway 162 coupled to the one or more loading ducts 152 and extending from a rail loading end 164 to a rail chamber end 166. The rail system 160 also comprises a rail mount 161 engageable with the railway 162 to facilitate movement of the rail mount 161 along the railway 162. As depicted in FIGS. 3 and 4, the irradiation frame 104 can be coupled to the rail mount 161 such that the irradiation frame 104 can travel within the loading duct 152 to and from the sample chamber 134. Indeed, as depicted in FIGS. 3 and 4, the railway 162 traverses the sample opening 136 and the rail chamber end 166 of the railway 162 terminates within the sample chamber 134. As shown in FIG. 3, the rail chamber end 166 of the railway 162 is coupled to the housing body 132 of the sample test housing 130 within the sample chamber 134. As shown in FIG. 5, the rail loading end 164 includes an extended loading segment 165 that extends outward from the loading end 154 of the loading duct 152. The extended loading segment 165 provides a location external to the loading duct 152 for coupling and uncoupling the irradiation frame 104 (and thereby the one or more test samples 102) to the rail mount 161. The extended loading segment 165 includes a mounting end 167 for coupling the extended loading segment 165 to the bunker wall 114. While a rail system 160 is depicted in FIGS. 3-5, other transport mechanisms are contemplated, such as a cable system, a rope system, or any other known or yet-to-be developed transport mechanism configurable to transport the irradiation frame 104 and the test sample 102 along the one or more loading ducts 152, for both loading and unloading operations.

Referring now to FIG. 6, in some embodiments, the sample loading system 150 further comprises one or more duct plugs 157, each removably positionable in the loading end 154 of the one or more loading ducts 152. The one or more duct plugs 157 may comprise one or more plug slats 158 and a plug basket 159. The one or more plug slats 158 each comprise a radiation shielding material, such as high-density polyethylene (HDPE), borated polyethylene, lead, or any other know or yet to be developed radiation shielding material. The one or more plug slats 158 are positioned in the plug basket 159, for example, removably positioned, and may be laterally spaced to provide openings for wiring connected to the one or more test samples 102 to exit the loading duct 152 when the irradiation frame 104 and test sample 102 are loaded in the sample chamber 134. Indeed, the loading duct 152 may provide a pathway for wiring of test samples 102 that comprises electronic components to reach above the water line 116, allowing the test samples 102 to be powered and operational during testing. The plug basket 159 comprises a perimeter lip that engages with the loading end 154 of the loading duct 152, holding the plug basket 159 and the one or more plug slats 158 in the loading duct 152 at the loading end 154. In some embodiments, the plug basket 159 includes one or more slots for holding the plug slats 158 is a laterally spaced arrangement. Moreover, when the duct plug 157 is positioned in the loading end 154 of one of the loading ducts 152, the one or more plug slats 158 block a neutron line of sight between the target chamber 128 and the loading end 154 of the loading duct 152. While the one or more duct plugs 157 are depicted in FIG. 6 as one or more plug slats 158 and the plug basket 159, embodiments are contemplated in which the one or more duct plugs are unitary duct plugs comprising a radiation shielding material that is unitary and is insertable into the loading end 154 of the loading duct 152. Moreover, embodiments are contemplated in which the one or more duct plugs 157 comprise insertable containers that are configured to hold water such that water held in these insertable containers may operate as the radiation shielding material of the one or more duct plugs 157.

Referring again to FIG. 2, the sample test housing 130 is coupled to a target support structure 170. The target support structure 170 comprises a base end 171 opposite an entry end 172, a plurality of support legs 173, and an intermediate shelf portion 174 positioned between the base end 171 and the entry end 172. The base end 171 is coupled to the bunker floor 112 of the bunker 110. As depicted in FIG. 2, the target support structure 170 further comprises an entry plate 178 positioned at the entry end 172. The entry plate 178 is coupled to the plurality of support legs 173 and includes a beamline opening 179. A portion of the beamline 122 of the neutron generator 120 extends through the beamline opening 179 such that the target chamber 128 of neutron generator 120 is positioned proximate the sample test housing 150, for example, surrounded by the sample test housing 130. The intermediate shelf portion 174 comprises at least one lateral support 175. For example, in the embodiment depicted in FIG. 2, the intermediate shelf portion comprises a first lateral support 175A coupled to the sample test housing 130 and a second lateral support 175B coupled to the one or more loading ducts 152 using one or more linking arms 176. In operation, the target support structure 170 provides support to the sample test housing 150 and the sample loading system 150 in situations when the water pool 115 is present in the bunker 110 and in situations when the water pool 115 is removed from the bunker 110.

Referring now to FIGS. 7 and 8, a radiation effects testing system 100′ is depicted. The radiation effects testing system 100′ comprises the neutron generator 120, the sample test housing 130, and an access tubing system 180 is schematically depicted. The access tubing system 180 comprises one or more access tubes 182 comprising a first end 184 and a second end 186, wherein the first end 184 is coupled to the sample test housing 130 to provide a pathway between the second end 186 of the access tube 182 and one or more sample chambers 134 of the sample test housing 130. The access tubes 182 may provide a pathway for wiring of test samples 102 that comprise electronic components to reach above the water line 116, for example, in embodiments that do not include the sample loading system 150. As shown in FIGS. 7 and 8, the second end 186 of each access tube 182 is positioned above the water line 116 of the water pool 115. While radiation effects testing system 100′ includes the access tubing system 180 and not the sample loading system 150, it should be understood that embodiments are contemplated comprising both the access tubing system 180 and the sample loading system 150.

Referring now to FIGS. 1 and 7, the radiation effects testing systems 100, 100′ may also include one or more auxiliary sample container systems 190. The one or more auxiliary sample container systems 190 provide an auxiliary container 192 for test samples 102 to be positioned in locations throughout the bunker 110, for example, positioned in the water pool 115. This allows the neutron dose applied to the test samples 102 to be varied, providing additional testing flexibility. For example, the one or more auxiliary sample container systems 190 may be used to determine a maximum neutron dose a test sample 102 can undergo, particularly when the dose rates in the sample test housing 150 are beyond that maximum. The auxiliary sample container systems 190 may further comprise a tether 194 to couple the auxiliary container 192 to the bunker floor 112 and/or a bunker wall 114, holding the auxiliary container under the water line 116, and an access tube 196 to provide a dry pathway for any wiring connected to the test sample 102 to reach above the water line 116.

Referring again to FIGS. 1-6, operation of the radiation effects testing system 100 will now be described. First, the one or more test samples 102 are loaded into the sample test housing 130, in particular, into one or more of the sample chambers 134 of the sample test housing 130. In the embodiments of the radiation effects testing system 100 of FIGS. 1-6, the one or more test samples 102 are loaded into the one or more sample chambers 134 using the sample loading system 150. In particular, one or more test samples 102 may be loaded into the irradiation frame 104, which may then be coupled to the rail mount 161 at the extending loading segment 165. The irradiation frame 104 may then be guided along the railway 162 to reach the sample chamber 134. For example, the irradiation frame 104 may be lowered along the railway 162, for example, using a cable system and/or winching device, assisted by gravity. The railway 162 may also include a translation mechanism to propel the irradiation frame 104 along the railway 162. For example, the railway 162 may include an electric translation mechanism with an electric motor or a pneumatic translation system with a pneumatic motor. While an electric translation mechanism is contemplated, it may be useful to limit the electronic components of the railway 162 as such components may be damaged by the radiation generated when testing the target sample 102. Once the irradiation frame 104 is loaded into the sample chamber 134, the duct plug 157 may be positioned in the loading end 154 of the loading duct 152. When loading the test sample 102 into the sample chamber 134 using the sample loading system 150, the water pool is present in the bunker 110 and the loading end 154 of the loading duct 152 is positioned above the water line 116.

Next, neutrons are generated in the target chamber 128 of the neutron generator 120 and at least a portion of the generated neutrons irradiate the one or more test samples 102 positioned in the one or more sample chambers 134 for an irradiation period. When generating neutrons in the target chamber 128, water is positioned in the bunker 110 forming the water pool 115 and the sample test housing 130 and the target chamber 128 are positioned in the water pool. After the irradiation period, the one or more test samples 102 are removed from the sample chamber 134, for example, using the sample loading system 150. For example, after the irradiation period, the duct plug 157 is removed from the loading end 154 of the loading duct 152 and the irradiation frame 104, and thereby the test sample 102, is transported from the sample chamber 134 along the railway 162, for example, using the cable system and/or winching device (or, in such embodiments, the electric translation system or the pneumatic translation system) to pull the irradiation frame 104 toward the loading end 154 of the loading duct 152, where the irradiation frame 104 and the test sample may be removed from the rail mount 151, allowing another test sample 102 to be tested.

Referring now to FIGS. 7 and 8, operation of the radiation effects testing system 100′ will now be described. First, the one or more test samples 102 are loaded into the sample test housing 130, in particular, into one or more of the sample chambers 134 of the sample test housing 130. In the embodiments of the radiation effects testing system 100 of FIGS. 1-6, the one or more test samples 102 are loaded directly into the one or more sample chambers 134. For example, the test sample 102 may be positioned on or in the irradiation frame 104 which is then loaded into a sample chamber 134 manually. When loading the one or more test samples 102 into the one or more sample chambers 134, the one or more sample chambers 134 are not positioned in the water pool 115, allowing direct access to the one or more sample chambers 134. When the test sample 102 is an electronic component, loading the test sample 102 also includes running wiring of the electronic component through one or more of the access tubes 182 to electrically couple the electronic component to a power source and one or more monitoring devices.

After loading the test sample 102 into the sample chamber 134 and prior to generating neutrons in the target chamber 128, water is directed into the bunker 110 to fill the water pool 115 such that the sample test housing 130 and the target chamber 128 are positioned in the water pool 115. Next, neutrons are generated in the target chamber 128 of the neutron generator 120 and at least a portion of the generated neutrons irradiate the one or more test samples 102 positioned in the one or more sample chambers 134 for an irradiation period. After the irradiation period, water is removed from the bunker 110 such that the sample test housing 130 and the target chamber 128 are not positioned in the water pool 115. After the water is removed, the one or more test samples 102 are removed from the sample chamber 134.

Referring again to FIGS. 1-8, the neutron generator 120 operates by extracting an ion beam of deuterium from the beam accelerator 124 and accelerating the deuterium beam via stepped electrostatic potentials such that a desired deuterium-tritium (DT) fusion cross-section is achieved when the deuterium beam enters the gaseous tritium target, located in the target chamber 128, generating neutrons via a fusion reaction. In operation, the ion beam may be accelerated and directed into the target chamber 128 as a continuous ion beam or a pulsed ion beam. The neutrons generated via the DT fusion reaction may comprise an average energy of greater than 8 MeV, for example, greater than 9 MeV, greater than 10 MeV, greater than 11 MeV, greater than 12 MeV, greater than 13 MeV, greater than 14 MeV, or any average in a range having any two of these values as endpoints. In some embodiments, the target chamber 128 may house a deuterium gas target such that the neutrons generated by a deuterium-deuterium (DD) fusion reaction. Such DD fusion neutrons may comprise an average energy of greater than 1 MeV, for example, greater than 1.5 MeV, greater than 2 MeV, greater than 2.5 MeV, greater than 3 MeV, or any average in a range having any two of these values as endpoints.

Without intending to be limited by theory, neutrons generated by a DT reaction (DT fusion neutrons) are particularly desirable for testing since they produce the desired ratio among hydrogen production rate, helium production rate, and displacement rates for an FPNS. For 14.1 MeV neutrons incident upon an iron target, the helium production rate to displacement rate ratio is 19.1 atomic parts per million (appm)/displacements per atom (dpa), and the hydrogen production rate to displacement rate ratio is 73.1 appm/dpa. As neutron energy is reduced from 14.1 MeV, hydrogen and helium production cross sections drop off much more quickly than displacement cross sections. As such, DT fusion neutrons are preferred over fission neutrons (i.e., neutrons produced by a fission reaction) which are mostly below 2 MeV and with near zero population at 10 MeV. In some embodiments, the neutrons generated via the fusion reaction in the target chamber 128 may comprise an average energy of greater than 10 MeV, for example, greater than 11 MeV, greater than 12 MeV, greater than 13 MeV, greater than 14 MeV, or an average energy in a range having any two or these values as endpoints.

As described above, the test sample 102 may comprise an electronic component, which may be tested while operating. For example, the electric component may be electrically coupled to a power source while the neutrons irradiate the electronic component. A component monitoring device, such as a computing device, may also be communicatively coupled to the electronic component, via a wired or wireless connection, to monitor the electronic component. Indeed, the method may further comprise operating the electronic component while neutrons irradiate the electronic component and monitoring operation of the of the electronic component while neutrons irradiate the electronic component. Monitoring operation of the electric component may include monitoring the operation of the hardware in the electric component and also the software operating on the electronic component. This includes monitoring whether any changes occur in the code as a result of interactions between the electronic component and radiation. The method may also include monitoring the radiation in the irradiation frame 104, sample test housing 130, and the bunker 110, using one or more radiation detection devices, such as a foil detector, a domino detector, a scintillator, and combinations thereof.

As the test sample 102 is being irradiated by neutrons a plurality of single even upsets occur, which may damage the test sample 102. In operation, a percentage of the plurality of single event upsets that are caused by neutrons having an energy greater than 10 MeV is 50% or greater, for example 55% or greater, 60% or greater, 65% or greater, 70% or greater, 75% or greater, 80% or greater, 85% or greater, 90% or greater, 95% or greater, 99% or greater, or a percentage in any range having any two of these values as endpoints.

Referring now to FIGS. 9A-9D, neutron flux modeling of the radiation effects testing system 100, 100′ is depicted. FIGS. 9A-9D include schematic depictions of the sample test housing 130 with the first housing body 132A housing the first sample chamber 134A, the second housing body 132B housing the second sample chamber 134B and the target chamber 128 positioned between the first sample chamber 134A and the second sample chamber 134B. In FIGS. 9A-9D, irradiation frames 104 are also depicted in each of the first and second sample chambers 134A, 134B. FIGS. 9A and 9B depict thermal neutron flux modeling when the irradiation frame 104 includes the neutron absorption liner 106 (FIG. 9A) and does not include the neutron absorption liner 106 (FIG. 9B). FIGS. 9C and 9D depict fusion neutron flux modeling when the irradiation frame 104 includes the neutron absorption liner 106 (FIG. 9C) and does not include the neutron absorption liner 106 (FIG. 9D). Neutron flux model 10 of FIG. 9A and neutron flux model 10′ of FIG. 9B, each depict the thermal neutron flux, specifically thermal neutrons with an energy of less than 0.5 eV, throughout the irradiation frames 104 and the sample test housing 130. Neutron flux model 10 of FIG. 9C and neutron flux model 20′ of FIG. 9D, each depict the fusion neutron flux, specifically fusion neutrons with an energy of greater than 10 MeV, throughout the irradiation frames 104 and the sample test housing 130.

As depicted in FIGS. 9A-9D, including the neutron absorption liner 106 reduces the thermal neutron flux in the irradiation frame 104, thus reducing the thermal neutron flux irradiating the test sample 102, while having minimal effect on the fusion neutron flux. Thus, including the neutron absorption liner 106, the percentage of neutrons present in the irradiation frame 104 that comprise fusion neutrons having an energy of greater than 10 MeV increases as the neutron absorption liner 106 absorbs or otherwise blocks the lower energy thermal neutrons but has a minimal effect on the higher energy fusion neutrons. FIGS. 9C and 9D also show the uniformity of the fusion flux field, particularly in the vertical direction. Thus, the test sample 102 may be selectively positioned in the irradiation frame 104 to receive a custom neutron dose that is substantially uniform along a vertical plane. Moreover, reducing the percentage of neutrons present in the irradiation frame 104 that comprise thermal neutrons reduces unnecessary neutron activations, which occur between thermal neutrons and the test sample 102 at an outsized rate because thermal neutrons have a higher cross section for neutron activation than fusion neutrons. Thus, minimizing thermal neutrons reduces unwanted damage and radioactivity to the test sample 102 caused by thermal neutrons. when testing the effect of high energy fusion neutrons on materials, thermal neutrons could cause errors in the measurements and not provide results indicative of high energy fusion neutron irradiation.

The test samples 102 may be positioned nearer to the target chamber 128 to receive a higher neutron dose and may be positioned farther from the target chamber 128 to receive a lower neutron dose. Moreover, the neutron dose received by the target sample 102 is substantially uniform along the vertical plane regardless of the position of the target sample 102 in the target chamber 134 and in the bunker 110. In operation, fusion neutrons are generated in the target chamber 128 as a line source, in contrast to a point source. Thus, the neutron flux decreases by a factor closer to 1/r than 1/r², where r is a distance from a location (i.e., a location in the bunker 110, for example, the location of the target sample 102) from the neutron source in the target chamber 128, which aligns with a beam axis of the ion beam entering the target chamber 128. Without intending to be limited by theory, an infinite line source of neutrons generates a neutron flux that decreases by a factor of 1/r and a point source of neutrons generates a neutron flux that decreases by a factor of 1/r². Using the neutron generator 120 of the radiation effects testing systems 100, 100′ described herein, the neutron flux decreases by a factor in a range of from about 1/r^{1.2} to about 1/r^{1.5}, for example, about 1/r^{1.25}, 1/r^{1.3}, 1/r^{1.35}, 1/r^{1.4}, 1/r^{1.45} or any value in a range having any two of those values as endpoints. Thus, the neutron flux of fusion neutrons generated in the target chamber 128 decreases at a lower rate when moving away from the target chamber 128, in contrast to point sources of neutrons.

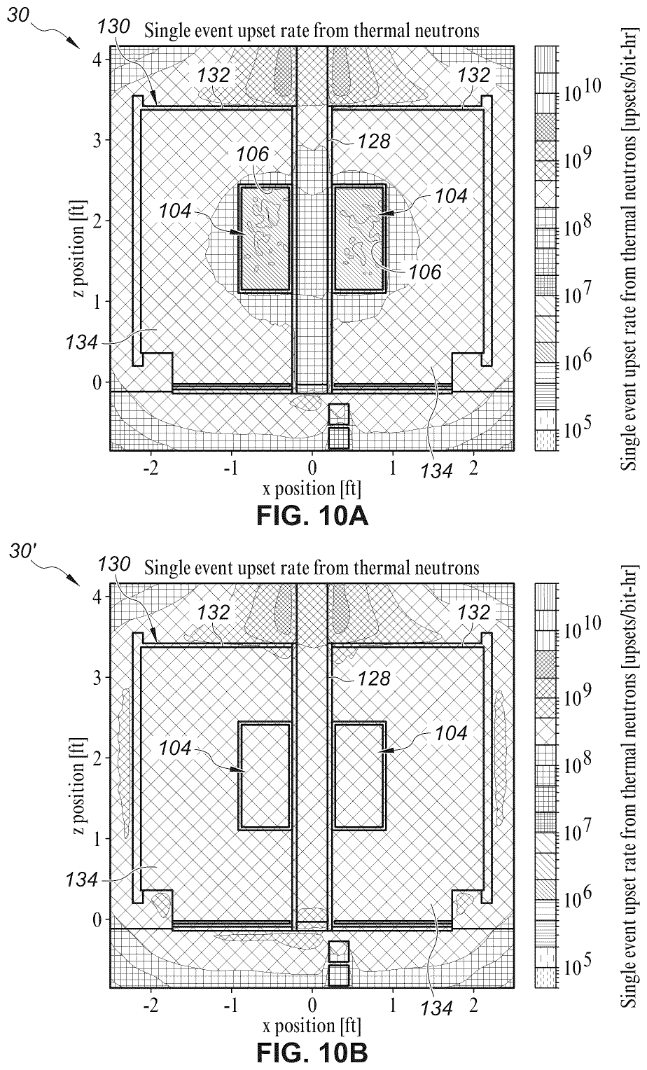

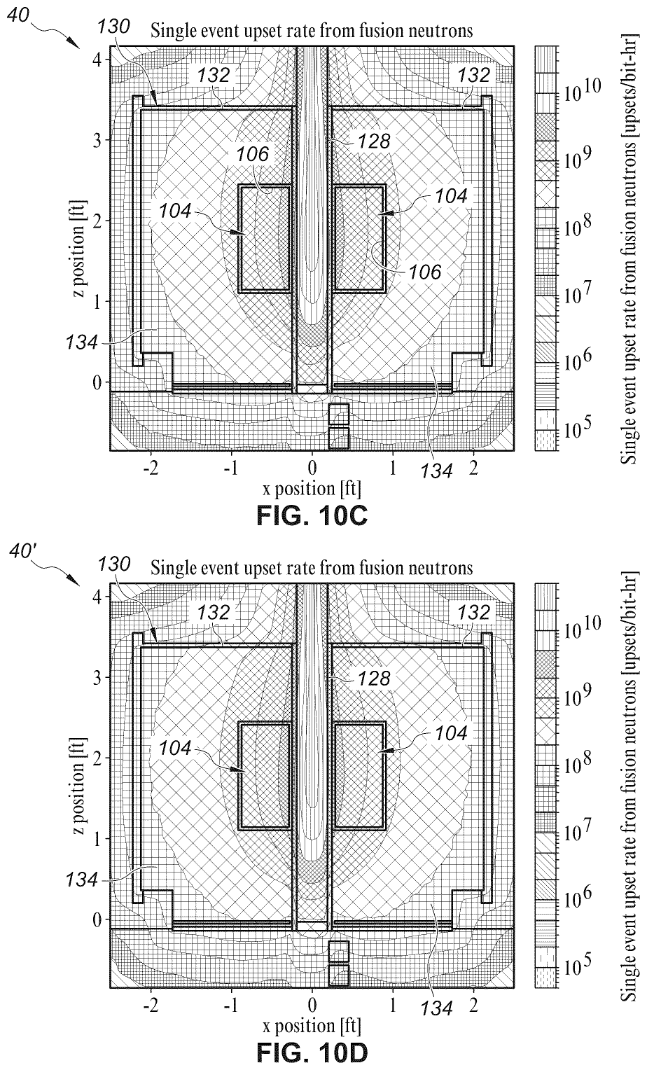

Referring now to FIGS. 10A-10D, single event upset (SEU) rate modeling of the radiation effects testing system 100, 100′ is depicted. FIGS. 10A-10D include schematic depictions of the sample test housing 130 with the first housing body 132A housing the first sample chamber 134A and the second housing body 132B housing the second sample chamber 134B and the target chamber 128 positioned between the first sample chamber 134A and the second sample chamber 134B. In FIGS. 10A-10D, irradiation frames 104 are also depicted in each of the first and second sample chambers 134A, 134B. FIGS. 10A and 10B depict a SEU rate from thermal neutrons when the irradiation frame 104 includes the neutron absorption liner 106 (FIG. 10A) and does not include the neutron absorption liner 106 (FIG. 10B). FIGS. 9C and 9D depict an SEU rate from fusion neutrons when the irradiation frame 104 includes the neutron absorption liner 106 (FIG. 10C) and does not include the neutron absorption liner 106 (FIG. 10D). SEU model 30 of FIG. 10A and SEU model 30′ of FIG. 10B, each depict the SEU rate from thermal neutrons, specifically thermal neutrons with an energy of less than 0.5 eV, throughout the irradiation frames 104 and the sample test housing 130. SEU model 40 of FIG. 10C and neutron flux model 40′ of FIG. 9D, each depict the SEU rate from fusion neutrons, specifically fusion neutrons with an energy of greater than 10 MeV, throughout the irradiation frames 104 and the sample test housing 130. As depicted in FIGS. 10A-10D, including the neutron absorption liner 106 reduces the SEU rate from thermal neutrons in the irradiation frame 104, thus reducing the SEU rate from thermal neutrons in the test sample 102, while having minimal effect on the SEU rate from fusion neutrons.

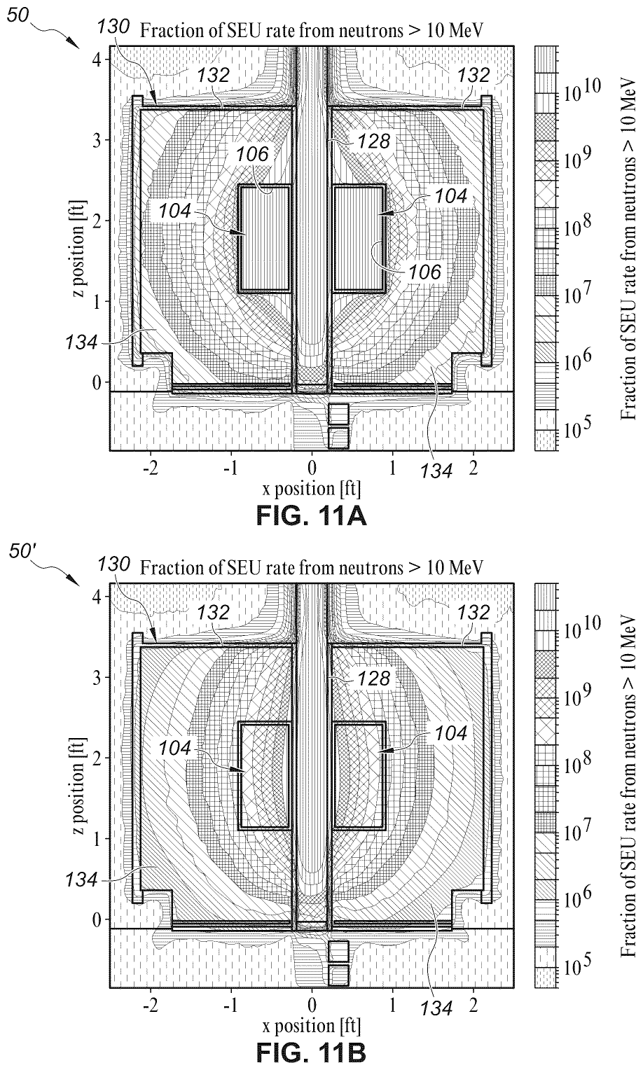

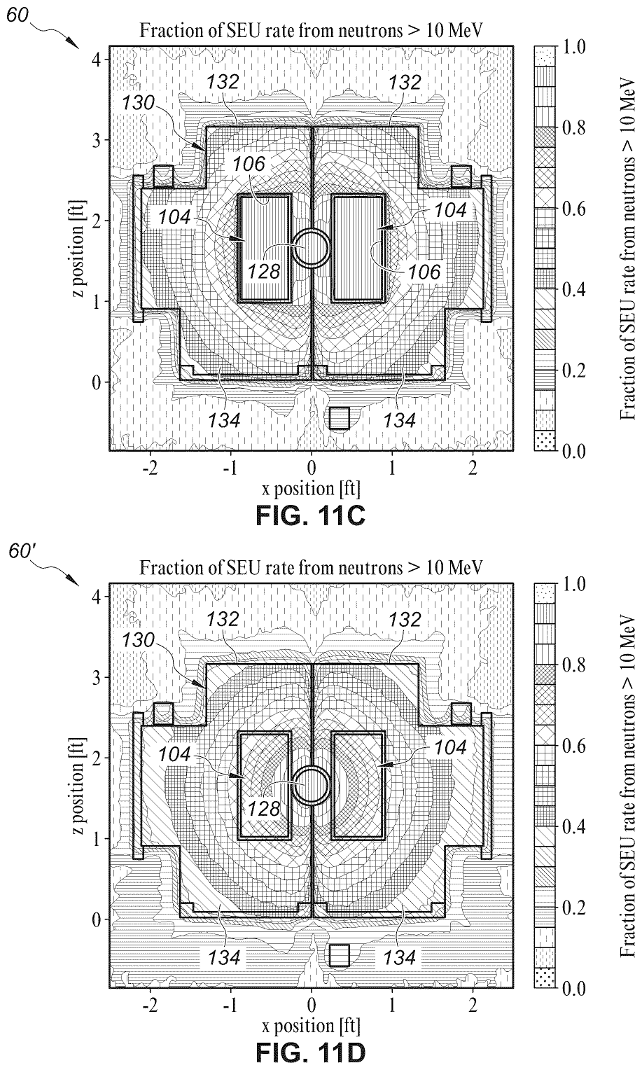

Referring now to FIGS. 11A-11D, SEU rate modeling from fusion neutrons comprising an energy greater than 10 MeV in the radiation effects testing system 100, 100′ is depicted. FIGS. 11A-11D include schematic depictions of the sample test housing 130 with the first housing body 132A housing the first sample chamber 134A and the second housing body 132B housing the second sample chamber 134B and the target chamber 128 positioned between the first sample chamber 134A and the second sample chamber 134B. In FIGS. 11A-11D, irradiation frames 104 are also depicted in each of the first and second sample chambers 134A, 134B. FIGS. 11A and 11B depict a fraction of the total SEU rate that comes from fusion neutrons comprising an energy greater than 10 MeV when the irradiation frame 104 includes the neutron absorption liner 106 (FIG. 11A) and does not include the neutron absorption liner 106 (FIG. 11B) along a vertical plane. FIG. 11C depicts FIG. 11A along a horizontal plane. Similarly, 11D depicts FIG. 11B along the horizontal frame. SEU fraction model 50 of FIG. 11A and SEU fraction model 50′ of FIG. 11B, each depict fraction of the total SEU rate that comes from fusion neutrons comprising an energy greater than 10 MeV throughout the irradiation frames 104 and the sample test housing 130 along a vertical plane. SEU fraction model 60 of FIG. 11C is the SEU fraction model 50 of FIG. 11A along a horizontal plane and SEU fraction model 60′ of FIG. 11D is the SEU fraction model 50′ of FIG. 11B along the horizontal plane. As depicted in FIGS. 10A-10D, including the neutron absorption liner 106 increases the fraction of the SEU rate in the irradiation frame 104 caused by fusion neutrons having an energy of greater than 10 MeV. This allows the test sample 102 to be tested under high energy neutron conditions, such conditions which are not readily available using other neutron sources, such as nuclear power reactors.

According to a first aspect of the present disclosure a radiation effects testing system comprises a sample test housing comprising a housing body and a sample chamber within the housing body and a neutron generator comprising a beam accelerator configured to generate an ion beam, a target chamber, and a beamline extending from the beam accelerator to the target chamber, wherein the sample test housing and target chamber are each housed in a bunker comprising a bunker floor and one or more bunker walls, water is positioned in the bunker forming a water pool, and the sample test housing and the target chamber are positioned in the water pool.

A second aspect includes the first aspect, wherein the sample test housing and the target chamber are positioned in the water pool wholly below a water line of the water pool.

A third aspect includes the first aspect or the second aspect, wherein the target chamber is positioned such that the sample test housing surrounds the target chamber.

A fourth aspect includes any of the first through third aspects, wherein the sample test housing further comprises a source receiving slot and the target chamber is positioned in the source receiving slot of the sample test housing such that the sample test housing surrounds the target chamber.

A fifth aspect includes any of the first through fourth aspects, further comprising a sample loading system comprising a loading duct comprising a loading end and a chamber end, wherein the chamber end is coupled to a sample opening of the sample test housing, thereby providing a pathway from the loading end into the sample chamber.

A sixth aspect includes the fifth aspect, wherein the loading end of the loading duct is positioned above a water line of the water pool.

A seventh aspect includes the fifth aspect or the sixth aspect, wherein the sample loading system further comprises an irradiation frame translatable along the loading duct and positionable within the sample chamber, wherein the irradiation frame is configured to hold one or more test samples.

An eighth aspect includes the seventh aspect, wherein a neutron absorption liner is positioned inside the irradiation frame.

A ninth aspect includes the seventh aspect or the eighth aspect, wherein a rail system is positioned in the loading duct and the irradiation frame is configured to travel along the rail system.

A tenth aspect includes any of the fifth through ninth aspects, wherein the sample loading system further comprises a duct plug removably positionable in the loading end of the loading duct and when the duct plug is positioned in the loading end of the loading duct, the duct plug blocks a neutron line of sight between the target chamber and the loading end of the loading duct.

An eleventh aspect includes any of the fifth through tenth aspects, wherein the housing body of the sample test housing is a first housing body, the sample chamber of the sample test housing is a first sample chamber, the sample opening of the sample test housing is a first sample opening, the sample test housing further comprises a second housing body, a second sample chamber within the second housing body, and a second sample opening, the loading duct of the sample loading system is a first loading duct and is coupled to the first sample opening at the chamber end of the first loading duct, and the sample loading system further comprises a second loading duct comprising a chamber end and a loading end, wherein the chamber end of the second loading duct is coupled to the second sample opening of the sample test housing, thereby providing a pathway from the loading end of the second loading duct into the second sample chamber.

A twelfth aspect includes the eleventh aspect, wherein the first housing body is coupled to the second housing body, the first housing body and the second housing body collectively surrounding the target chamber.

A thirteenth aspect includes any of the first through twelfth aspect, further comprising an access tubing system comprising an access tube comprising a first end and a second end, wherein the first end is coupled to the sample test housing to provide a pathway between the second end of the access tube and the sample chamber.

A fourteenth aspect includes the thirteenth aspect, wherein the second end is positioned above a water line of the water pool.

A fifteenth aspect includes any of the first though fourteenth aspects, wherein the neutron generator further comprises a low-pressure chamber positioned along the beamline between the beam accelerator and the target chamber, the target chamber houses tritium, and the ion beam comprises a deuterium beam.

A sixteenth aspect includes any of the first through fifteenth aspects, further comprising a target support structure coupled to the sample test housing.

A seventeenth aspect includes the sixteenth aspect, wherein the target support structure comprises a base end opposite an entry end, a plurality of support legs, an intermediate shelf portion positioned between the base end and the entry end, and an entry plate positioned at the entry end, wherein the entry plate comprises a beamline opening.

According to an eighteenth aspect of the present disclosure, a method of performing radiation effects testing comprises loading a test sample into a sample chamber of a sample test housing, generating neutrons in a target chamber of a neutron generator positioned such that the neutrons irradiate the test sample in the sample chamber, and removing the test sample from the sample chamber, wherein the sample test housing and target chamber are each housed in a bunker comprising a bunker floor and one or more bunker walls and when generating neutrons in the target chamber, water is positioned in the bunker forming a water pool such that the sample test housing and the target chamber are positioned in the water pool.

A nineteenth aspect includes the eighteenth aspect, wherein the target chamber is positioned such that the sample test housing surrounds that target chamber.

A twentieth aspect includes the eighteenth or nineteenth aspects, wherein generating neutrons comprises accelerating an ion beam from a beam accelerator into the target chamber such that the ion beam interacts with a target to generate the neutrons via a fusion reaction.

A twenty-first aspect includes the twentieth aspect, wherein the neutrons generated via the fusion reaction comprise an average energy of greater than 10 MeV.

A twenty-second aspect includes any of the eighteenth through twenty-first aspects, wherein the loading the test sample into the sample chamber of the sample test housing comprises loading an irradiation frame holding the test sample into the sample chamber.

A twenty-third aspect includes the twenty-second aspect, wherein a neutron absorption liner is positioned inside the irradiation frame.

A twenty-fourth aspect includes any of the eighteenth through twenty-third aspects, wherein the test sample comprises an electronic component.

A twenty-fifth aspect includes the twenty-fourth aspect, wherein the electronic component is electrically coupled to a power source while the neutrons irradiate the electronic component.

A twenty-sixth aspect includes the twenty-fourth aspect, further comprising, operating the electronic component while neutrons irradiate the electronic component, and monitoring operation of the electronic component while neutrons irradiate the electronic component.

A twenty-seventh aspect includes any of the eighteenth through twenty-sixth aspects, wherein the test sample is loaded into the sample chamber using a sample loading system, the sample loading system comprising a loading duct coupled to a sample opening of the sample housing.

A twenty-eighth aspect includes the twenty-seventh aspect, wherein the sample loading system further comprises an irradiation frame and the test sample is held by the irradiation frame and the irradiation frame is translatable along the loading duct and positionable in the sample chamber.

A twenty-ninth aspect includes the twenty-eighth aspect, wherein the irradiation frame is removably coupled to a rail system positioned within the loading duct.

A thirtieth aspect includes the twenty-ninth aspect, wherein a rail system is positioned in the loading duct and the irradiation frame is configured to travel along the rail system.

A thirty-first aspect includes any of the twenty-seventh through thirtieth aspects, wherein when loading the test sample into the sample chamber using the sample loading system, the water pool is present in the bunker.

A thirty-second aspect includes any of the eighteenth through thirty-first aspects, wherein when loading the test sample into the sample chamber, the sample test housing and the target chamber are not positioned in the water pool.

A thirty-third aspect includes the thirty-second aspect, wherein, after loading the test sample into the sample chamber, the method further comprises directing water into the bunker such that the sample test housing and the target chamber are positioned in the water pool when generating neutrons in the target chamber.

A thirty-fourth aspect includes the thirty-third aspect, wherein, after generating neutrons in a target chamber and prior to removing the test sample from the sample chamber, the method further comprises removing water from the bunker such that the sample test housing and the target chamber are not positioned in the water pool.

A thirty-fifth aspect includes any of the eighteenth through thirty-fourth aspects, wherein a plurality of single event upsets occur in the test sample when neutrons irradiate the test sample in the sample chamber, a percentage of the plurality of single event upsets that are caused by neutrons having an energy greater than 10 MeV is 60% or greater.

A thirty-sixth aspect includes any of the eighteenth through thirty-fifth aspects, wherein a plurality of single event upsets occur in the test sample when neutrons irradiate the test sample in the sample chamber, a percentage of the plurality of single event upsets that are caused by neutrons having an energy greater than 10 MeV is 90% or greater.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. Thus, it is intended that the specification cover the modifications and variations of the various embodiments described herein provided such modification and variations come within the scope of the appended claims and their equivalents.

As utilized herein, the terms “approximately,” “about,” “substantially”, and similar terms are intended to have a broad meaning in harmony with the common and accepted usage by those of ordinary skill in the art to which the subject matter of this disclosure pertains. Indeed, such terms refer to the subsequently listed property or measurement within normal manufacturing tolerances and imperfections in the relevant field. It should be understood by those of skill in the art who review this disclosure that these terms are intended to allow a description of certain features described and claimed without restricting the scope of these features to the precise numerical values or idealized geometric forms provided. Accordingly, these terms should be interpreted as indicating that insubstantial or inconsequential modifications or alterations of the subject matter described and claimed are considered to be within the scope of the disclosure as recited in the appended claims.

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

What is claimed is:

1. A radiation effects testing system comprising:
a sample test housing comprising a housing body and a sample chamber within the housing body; and
a neutron generator comprising a beam accelerator configured to generate an ion beam, a target chamber, and a beamline extending from the beam accelerator to the target chamber, wherein:
the sample test housing and target chamber are each housed in a bunker comprising a bunker floor and one or more bunker walls;
water is positioned in the bunker forming a water pool; and
the sample test housing and the target chamber are positioned in the water pool.

2. The radiation effects testing system of claim 1, wherein the target chamber is positioned such that the sample test housing surrounds the target chamber.

3. The radiation effects testing system of claim 1, wherein the sample test housing further comprises a source receiving slot and the target chamber is positioned in the source receiving slot of the sample test housing such that the sample test housing surrounds the target chamber.

4. The radiation effects testing system of claim 1, further comprising a sample loading system comprising a loading duct comprising a loading end and a chamber end, wherein:
the chamber end is coupled to a sample opening of the sample test housing, thereby providing a pathway from the loading end into the sample chamber; and
the loading end of the loading duct is positioned above a water line of the water pool.

5. The radiation effects testing system of claim 4, wherein the sample loading system further comprises an irradiation frame translatable along the loading duct and positionable within the sample chamber, wherein the irradiation frame is configured to hold one or more test samples.

6. The radiation effects testing system of claim 5, wherein a neutron absorption liner is positioned inside the irradiation frame.

7. The radiation effects testing system of claim 5, wherein a rail system is positioned in the loading duct and the irradiation frame is configured to travel along the rail system.

8. The radiation effects testing system of claim 4, wherein the sample loading system further comprises a duct plug removably positionable in the loading end of the loading duct and when the duct plug is positioned in the loading end of the loading duct, the duct plug blocks a neutron line of sight between the target chamber and the loading end of the loading duct.

9. The radiation effects testing system of claim 1, further comprising an access tubing system comprising an access tube comprising a first end and a second end, wherein the first end is coupled to the sample test housing to provide a pathway between the second end of the access tube and the sample chamber.

10. The radiation effects testing system of claim 1, wherein:
the neutron generator further comprises a low-pressure chamber positioned along the beamline between the beam accelerator and the target chamber;
the target chamber houses tritium; and
the ion beam comprises a deuterium beam.

11. A method of performing radiation effects testing, the method comprising:
loading a test sample into a sample chamber of a sample test housing;
generating neutrons in a target chamber of a neutron generator positioned such that the neutrons irradiate the test sample in the sample chamber; and
removing the test sample from the sample chamber, wherein:
the sample test housing and target chamber are each housed in a bunker comprising a bunker floor and one or more bunker walls; and
when generating neutrons in the target chamber, water is positioned in the bunker forming a water pool such that the sample test housing and the target chamber are positioned in the water pool.

12. The method of claim 11, wherein the target chamber is positioned such that the sample test housing surrounds that target chamber.

13. The method of claim 11, wherein generating neutrons comprises accelerating an ion beam from a beam accelerator into the target chamber such that the ion beam interacts with a target to generate the neutrons via a fusion reaction.

14. The method of claim 11, wherein loading the test sample into the sample chamber of the sample test housing comprises loading an irradiation frame holding the test sample into the sample chamber.

15. The method of claim 14, wherein a neutron absorption liner is positioned inside the irradiation frame.

16. The method of claim 11, wherein the test sample comprises an electronic component and the method further comprises operating the electronic component while neutrons irradiate the electronic component and monitoring operation of the electronic component while neutrons irradiate the electronic component.

17. The method of claim 11, wherein the test sample is loaded into the sample chamber using a sample loading system, the sample loading system comprising a loading duct coupled to a sample opening of the sample housing and an irradiation frame, wherein the test sample is held by the irradiation frame and the irradiation frame is translatable along the loading duct and positionable in the sample chamber.

18. The method of claim 17, wherein the irradiation frame is removably coupled to a rail system positioned within the loading duct, a rail system is positioned in the loading duct, and the irradiation frame is configured to travel along the rail system.

19. The method of claim 17, wherein when loading the test sample into the sample chamber using the sample loading system, the water pool is present in the bunker.

20. The method of claim 11, wherein:
when loading the test sample into the sample chamber, the sample test housing and the target chamber are not positioned in the water pool;
after loading the test sample into the sample chamber, the method further comprises directing water into the bunker such that the sample test housing and the target chamber are positioned in the water pool when generating neutrons in the target chamber; and
after generating neutrons in a target chamber and prior to removing the test sample from the sample chamber, the method further comprises removing water from the bunker such that the sample test housing and the target chamber are not positioned in the water pool.
